(19) United States
(12) Patent Application Publication
(10) Pub. No.: US 2023/0122349 A1
(43) Pub. Date: Apr. 20, 2023

(54) PRINT HEADS AND CONTINUOUS PROCESSES FOR PRODUCING ELECTRICALLY CONDUCTIVE MATERIALS

(71) Applicant: Soliyarn LLC, Boston, MA (US)

(72) Inventors: Trisha Lionel Andrew, Hadley, MA (US); Morgan Baima, McKinney, TX (US); Adrian J. Beach, Arlington, MA (US)

(21) Appl. No.: 17/914,633

(22) PCT Filed: Mar. 22, 2021
(86) PCT No.: PCT/US2021/023412

§ 371 Date: Sep. 26, 2022

Related U.S. Application Data
(60) Provisional application No. 62/994,533, filed on Mar. 25, 2020.
(60) Provisional application No. 62/994,553, filed on Mar. 25, 2020.

(51) Int. Cl. H01B 13/00; H01B 1/12; H01B 3/50; B05D 1/00

(52) U.S. Cl. CPC H01B 13/0036; B05D 1/60; H01B 1/127; H01B 3/50

(57) ABSTRACT

Systems and devices for continuous, high-throughput production of electrically conductive yans, fibers or fabrics. In one embodiment, the system comprises a first process chamber for coating the yarn, fiber or fabric with an electrically conductive material and a second process chamber for encapsulating the electrically conductive yarn, fiber or fabric with an encapsulating material. In another embodiment, device for printing an encapsulated electrically conductive material on a yarn, fiber or fabric, includes print head(s) for coating and encapsulating a yarn, fiber or fabric.

### CROSS REFERENCE TO RELATED APPLICATIONS

This application is a national stage application under 35 U.S.C. §371 of International Application No. PCT/US2021/023412, filed Mar. 22, 2021, which claims priority under applicable portions of 35 U.S.C. §119 to U.S. Pat. Application Serial Nos. 62/994,533 and 62/994,553, both filed Mar. 25, 2020, the entire contents of each application being herein incorporated by reference herein.

### TECHNICAL FIELD

This application is generally directed to the field of electrically conductive materials, such as textiles, yarns, fibers and fabrics, and more particularly to continuous processes for producing electrically conductive textiles, such as yarn, fiber or fabric.

### BACKGROUND

Conventional processes for producing materials, such as textiles, fibers, yarns, and fabrics are solvent based. In those processes, raw materials or partially finished fibers and yarns can be colored with dyes, and treated for color fastness, feel, etc. In conventional processes, the items to be processed are introduced into vats containing treatment chemicals, surfactants and lubricants in a solvent. After processing, excess chemicals in the fabric are rinsed out using more solvent, leading to contaminated rivers and groundwater. The environmental impacts of such processes are significant, but these conventional techniques are widely used because they offer high-throughput production of conventional fibers and fabrics.

In addition to the environmental impact of conventional processes, these processes are not capable of producing electrically conductive yarn, fibers or fabric that are mechanically robust and can withstand multiple washings. The unsuitability arises due to incompatibilities between the chemistry, substrate and form/function of electrically conductive fabrics and conventional processes.

Therefore, a prevailing need in the field exists for improved processes for producing yarns, fibers and fabrics, including those that are compatible with electrically conductive materials.

### BRIEF DESCRIPTION

Therefore, in one embodiment, a system comprises a first process chamber for coating a yarn, fiber or fabric with an electrically conductive material to produce an electrically conductive yarn, fiber or fabric and a second process chamber for encapsulating the electrically conductive yarn, fiber or fabric with an encapsulating material.

In another embodiment, a device is provided for printing an encapsulated electrically conductive material onto any flat or smooth plastic, paper, transparent conducting oxide or metal oxide surface, or nonwoven, prewoven or knit fabric surface, including print head(s) for coating and encapsulating a yarn, fiber or fabric.

The above embodiments are exemplary only. Other embodiments as described herein are within the scope of the disclosed subject matter.

### BRIEF DESCRIPTION OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views, in which:

FIG. 1 illustrates an embodiment of a system for producing electrically conductive yarn, fiber or fabric, in which a raw material is located within one or more process chambers during processing, in accordance with one or more aspects set forth herein;

FIG. 2 illustrates an embodiment of a system for producing electrically conductive yarn, fiber or fabric with an encapsulating material, in which a raw material is continuously fed into one or more process chambers during processing, in accordance with one or more aspects set forth herein;

FIG. 3A depicts a coating chamber, in accordance with one or more aspects set forth herein;

FIG. 3B depicts further details of coating yarn, fiber or fabric, in accordance with one or more aspects set forth herein;

FIG. 3C depicts a technique for coating yarn fiber or fabric, in accordance with one or more aspects set forth herein;

FIG. 4 depicts a cleaning chamber, in accordance with one or more aspects set forth herein; and

FIGS. 5A & 5B depict embodiments of encapsulating chambers, in accordance with one or more aspects set forth herein; and

FIGS. 6A & 6B illustrate embodiments of print heads for producing electrically conductive or protected substrates, such as flat or smooth plastic, paper, transparent conducting oxide or metal oxide surface, or nonwoven, pre-woven or knit fabric surface, in which a raw material is printed or sprayed with electrically conductive coatings and/or encapsulating materials, in accordance with one or more aspects set forth herein.

Corresponding reference characters indicate corresponding parts throughout several views. The examples set out herein illustrate several embodiments, but should not be construed as limiting in scope in any manner.

### DETAILED DESCRIPTION

The present disclosure relates to high-throughput processes for producing electrically conductive materials, such as textiles, fibers, yarns or fabrics. Further details regarding electrically conductive fabrics and yarns may be found in, U.S. Pat. Publication No. 2019/0230745A1 (Andrew, Zhang and Baima), published Jul. 25, 2019, and entitled “Electrically-heated fiber, fabric, or textile for heated apparel,” and U.S. Pat. Publication No. 2018/0269006A1 (Andrew and Zhang), published Sep. 20, 2018, and entitled “Polymeric capacitors for energy storage devices, method of manufacture thereof and articles comprising the same,” each of which is incorporated herein in its entirety.

Generally stated, provided herein, in one embodiment, is a system for continuously producing electrically conductive yarn, fiber or fabric. The system includes a first, second and an optional third process chamber, and spooling mechanisms. For instance, the a first process chamber is for coating the yarn, fiber or fabric with an electrically conductive polymeric material. The first process chamber introduces a precursor and an initiator that form the electrically conductive polymeric material. And the second process chamber is for encapsulating the electrically conductive yarn, fiber or fabric with an encapsulating insulating material. A first spooling mechanism stores the yarn, fiber or fabric within the first process chamber and flows the yarn, fiber or fabric through the first process chamber during the coating. A second spooling mechanism accepts the yarn, fiber or fabric such that the yarn, fiber or fabric continuously flows in the direction from the first process chamber to the second process chamber. The flow rate of the first and second spooling mechanisms are selected to allow the yarn, fiber or fabric to be coated with the electrically conductive material and encapsulated with the encapsulating material. The yarn, fiber or fabric is subsequently spooled after the encapsulating to form a spool of yarn, fiber or fabric.

In one embodiment, the first and second process chambers are combined as a single process chamber. For example, separation of the coating and the encapsulating is achieved through one or more of space or a physical barrier within the single process chamber. In another embodiment, the process chamber comprises vapor phase introduction of the precursor and the initiator. For example, the precursor and initiator begin reacting in the vapor phase and the coating is formed conformally around the yarn, fiber or fabric as a molecular layer. In such a case, the forming process as a molecular layer retains flexibility of the yarn, fiber or fabric after the coating. In different embodiments, the precursor may be 3,4-ethylenedioxythiophene, the electrically conductive material may be p-doped poly(3,4-ethylenedioxythiophene), and the encapsulating material may be an acrylate.

In another aspect, a device for printing a pattern of encapsulating and/or electrically conductive polymer onto any flat or smooth plastic, paper, transparent conducting oxide or metal oxide surface, or nonwoven, prewoven or knit fabric surface includes at least one print head for heating at least one precursor material and producing at least one vapor within a target zone of the print head. For instance, the vapor comprises a precursor and an initiator, and the surface is coated with a pattern of an electrically conductive material and protected with an encapsulating material when passing within the target zone of the print head.

In one embodiment, the at least one print head comprises a first print head for coating the surface with the electrically conductive material, and a second print head for encapsulating the electrically conductive material with an encapsulating material. In another embodiment, the at least one print head comprises a single print head for coating the surface with the electrically conductive material, and for encapsulating the electrically conductive material with an encapsulating material. Further embodiments use heat-based and/or light-based initiation to coat with the encapsulating material.

By way of example, the electrically conductive material may comprise p-doped poly(3,4-ethylenedioxythiophene), and the encapsulating material may comprise a poly(acrylate). In another implementation, the device includes a portable unit, the device further comprising a battery and movable material tanks for storing. In a further implementation, the device further comprises an outlet for delivering a cleaning solution to the yarn, fiber or fabric.

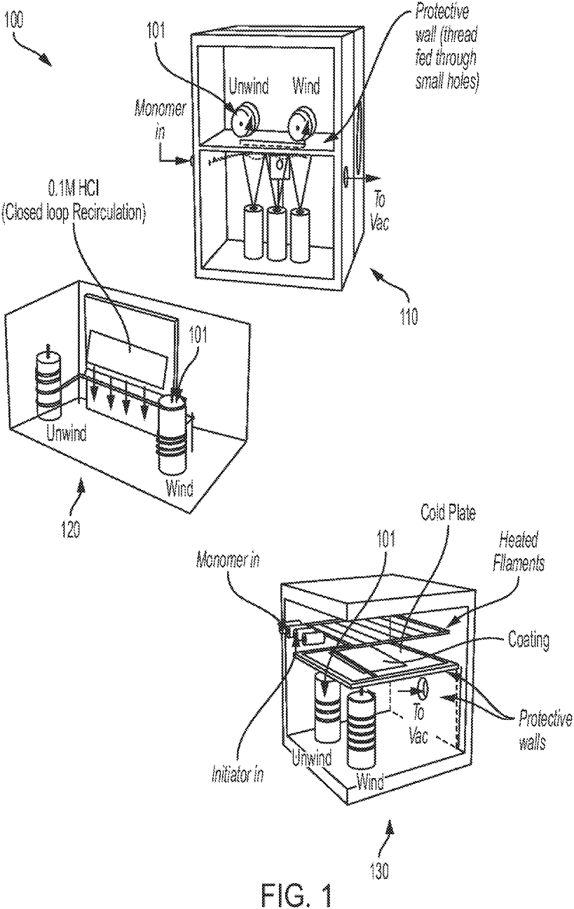

FIG. 1 illustrates a system 100 for producing electrically conductive and/or protective yarn, fiber or fabric. According to this embodiment, the system 100 includes a coating chamber 110, an optional cleaning chamber 120, and an encapsulating chamber 130. The chambers 110, 120, and 130 can be serially linked by conveyors or other transport means or can be separately disposed. An exemplary approach to creating functional yarns in for wearable energy storage in the system embodiment of FIG. 1 is to: start with familiar and mass-produced yarns, such as cotton; deposit an electrothermally-responsive coating onto the threads of the yarns that will transform them into Joule heaters using chambers 110 and 120. This coating will not alter their characteristic feel, weight or mechanical/tensile properties. Finally, these yarns will be encapsulated with a water-repellant insulating coating using chamber 130 to create durable heaters.

In the embodiment of FIG. 1, a spool 101 of raw material is first located within the coating chamber 110. To affect an electrothermal response, yarns will be coated with the persistently p-doped conducting polymer poly(3,4-ethylenedioxythiophene), PEDOT-C1, using a lab-scale vapor deposition chamber 110 whose design was adapted from previous efforts on the in situ vapor phase polymerization of 3,4-ethylenedioxythiophene (EDOT). The major components of this lab-scale chamber include: an electrical furnace to uniformly deliver FeC1₃ vapor to a sample stage situated between three to ten inches above the furnace; a heated sample stage between 5 square inches to 36 square inches; stainless steel tubing to deliver EDOT vapor from outside of the chamber; and an in situ quartz crystal microbalance (QCM) sensor to monitor the EDOT/FeCI₃ flow rates and thickness of the deposited PEDOT film in real time. Electrical heaters on the outside of the chamber near the EDOT inlets can be included to facilitate evaporation of the EDOT. Additional inert gases, such as nitrogen or argon, can be introduced into the chamber from a second gas inlet to control the process pressure and to deliver EDOT vapors. Vapor phase oligomerization and polymerization of EDOT is expected to occur in the regions where the monomer vapor flux intersects with the conical FeC1₃ vapor plume, and the resulting oligomers, which possess comparatively low kinetic energy, coats any surface placed within this region. A process pressure of 100-1000 mTorr during deposition translates into mean free paths on the order of millimeters for these reactive oligomers. Since these mean free paths are commensurate with the surface roughness of woven fabrics, the oligomers described herein are be able to sample multiple sites before finally adhering to a particular surface, yielding conformal coatings. Additionally, heating the sample stage during deposition imparts lateral mobility along the substrate surface to adsorbed oligomers, thus leading to better surface conformity and PEDOT conductivity. Stage heating also encourages oligomer-oligomer coupling to form higher molecular weight polymers.

The thickness of the growing polymer film inside the chamber is monitored in real time by a quartz crystal microbalance (QCM) sensor situated near the sample stage. The total deposition rate and film thickness values reported by the QCM sensor during vapor deposition arise from both the polymer film and unreacted EDOT/FeCI₃ being deposited onto the sensor surface. Thickest polymer films are obtained after rinsing when the EDOT and FeC1₃ flow rates are matched during deposition. Unreacted EDOT or FeC1₃ remain trapped in the films if their flow rates are mismatched, which are leached out of the film during rinsing, leading to significantly lower coating thicknesses than measured by the QCM sensor during deposition. Taking this into account, typical polymer growth rates are about 10 - 15 nm per minute of exposure to the reactive vapor cone, for a substrate stage temperature of 80° C.

Next, the spool of raw material is moved to the cleaning chamber 120. A post deposition rinse in the cleaning chamber 120 completely removes residual FeC1₃ trapped in the vapor deposited polymer films and yields metal free, PEDOT-C1 coated yarns. The post deposition rinse contains a dilute aqueous solution, 0.001 - 0.1 moles per litre, of an acid, either monoprotic or diprotic, and it will further dope the PEDOT film to improve the conductivity of the resulting fabric. After rinsing, warm air is blown through the fabric to dry it.

Finally and still referring to FIG. 1, the spool of raw material is moved to the encapsulating chamber 130. To encapsulate the PEDOT-C1 coated yarns with a water-repellant coating, a second lab-scale vapor deposition chamber 130 will be used whose design is adapted from previous efforts on the in situ radical chain polymerization of acrylate monomers. The major components of this lab-scale chamber include: a shallow, cylindrical stainless steel shell with small ports for gas flow in and out, heated filaments (typically nichrome) that can be resistively heated to 150-400° C., and a liquid-cooled stage on which the substrate is placed. For polymer film growth, an initiator and a monomer are vaporized by heat and reduced pressure. The vapors are then flowed over heated filaments to decompose the initiator into reactive radicals. The radical species and monomer condense on any substrate on the cooled stage, and the polymerization reaction occurs. Films are typically grown at pressures between 0.1-500 mTorr, and the rate of growth can be adjusted by changing the partial pressures of the initiator and monomer, chamber pressure and filament temperature. Typical polymer growth rates are 10 nm per minute of exposure to the reactive vapor. This encapsulation process is comparatively simpler and faster than the previous PEDOT-C1 coating operation and does not require a post-deposition rinse. In another embodiment, this process can also be achieved using UV light (wavelength <400 nm) in place of the wire heating filament to initiate the polymerization. For the light-initiated version, the reaction area is flooded with UV light, typically through a quartz glass window located in the ceiling of the vacuum chamber. In this case, the heated filament array is not needed, and a photoinitiator is used in place of a thermally-activated initiator.

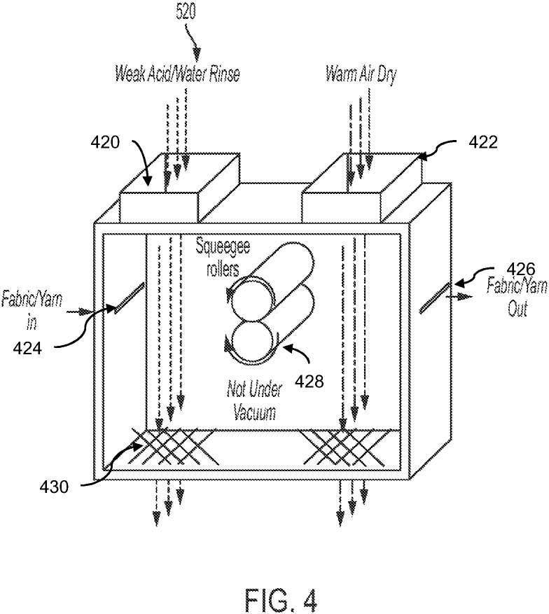

With respect to both the coating and encapsulation steps, the coating thickness can be varied from approximately 100 to 1000 nm. Highly-uniform and conformal coatings have been formed on an array of fabric and yarn surfaces that are exposed to the reactive vapor in both chambers, without any special pre-treatment or fixing steps. Further, polymer films are uniformly deposited (macroscopically) over the surface while also conformally wrapping (microscopically) the curved surface of each exposed fibril of the threads constituting the fabric. The high conformality of the conductive coating is particularly apparent in the SEM image of PEDOT-C1 coated wool gauze (FIG. 4), where the PEDOT-C1 film contours to all the exposed surface features of the fabric with high fidelity over multiple length scales. Cross-section SEM studies have confirmed that the PEDOT and protective acrylate films are purely surface coatings and that the bulk of fibrils/threads are not swelled or dyed by the polymers. Successful vapor coatings have been carried out without any pre-treatment steps, regardless of surface chemistry, thread/yarn composition and weave density. The polymer coatings did not change the feel of any of the fabrics, as determined by touching the fabrics with bare hands before and after coating. Further, the coatings did not increase the weight of the fabrics by more than 2%.

In order to increase the coating thickness and throughput, the total dwell time in a deposition zone and the stage temperature are the two variables requiring evaluation. A meandering loop design is used to increase the total dwell time experienced by a unit length of yarn as it passes through the deposition zones in each of the two polymer deposition chambers. Stage temperatures are more difficult since there will be a 2D distribution across the plate, however, thermocouples will be instrumented across the stage to compare the ‘local’ temperatures to the quality of coat. The local temperatures and corresponding regions of yarn can be used to correlate the effect of temperature with better resolution. Chamber pressures can also be used to tightly-control coating uniformity while increased throughput speed. Increased (>300 mTorr) chamber pressures then result in shorter mean free paths for the chemical species responsible for polymer chain growth in the chamber, which, in turn, afford greater surface coverage due to a higher frequency of surface-restricted reactions and suppression of line-of-sight deposition events.

By way of further explanation, in one embodiment, the poly(3,4-ethylenedioxythiophene) film formed from vapor phase polymerization using an iron salt is advantageous. In one embodiment, the dopant is uniformly distributed through the p-doped PEDOT film. In an embodiment, the poly(3,4-ethylenedioxythiophene) is uniformly doped having a dopant concentration of 10¹⁰ atoms per cm³ to 1020 atoms per cm³ and a concentration variation of ±10³ atoms per cm³.

The 3,4-ethylenedioxythiophene has the structure of formula (1):

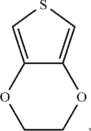

Upon polymerization, this has the structure of formula (2):

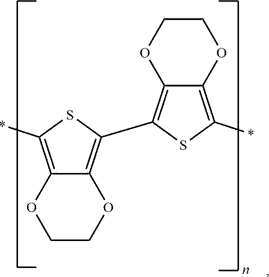

where “n” is the number of repeat units.

In an embodiment, n (the number of repeat units) may be greater than 20, preferably greater than 30, and more preferably greater than 40. In an embodiment, n is 20 to 10,000, preferably 50 to 9000, and more preferably 100 to 8500.

The iron salt may be any salt that can be vaporized (either by boiling or sublimation) at the reaction temperature. The iron salts may be divalent iron salts, trivalent iron salts, or a combination thereof. It is generally desirable for the iron salts to be trivalent iron salts. Examples of salts are iron (III) chloride, iron (III) bromide, iron (III) acetylacetonate, iron (III) sulfate, iron (III) acetate, iron(III) p-toluenesulfonate, or the like, or a combination thereof.

The amount of the 3,4-ethylenedioxythiophene vapor in the reactor is 20 to 80 volume percent, preferably 40 to 60 volume percent relative to the volume of the sum of the vapors of 3,4-ethylenedioxythiophene and the iron-salt. The amount of iron salt in the reactor is 20 to 80 volume percent, preferably 40 to 60 volume percent relative to the volume of the sum of the vapors of 3,4-ethylenedioxythiophene and the iron-salt. Other inert gases such as nitrogen and argon may be present in the reactor during the reaction.

The substrate upon which the film is disposed is an electrically insulating substrate. Electrically conducting substrates are those that have an electrical volume resistivity of less than or equal to 1 _{X} 10¹¹ ohm-cm, while electrically conducting substrates are those that have an electrical volume resistivity of greater than 1 _{X} 10¹¹ ohm-cm. The substrate may be in the form of a slab, a thin film or sheet having a thickness of several nanometers to several micrometers (e.g., 10 nanometers to 1000 micrometers), woven or non-woven fibers, yarns, a fabric, a gel, a pixel, a particle, or the like. The substrate may have a smooth surface (e.g., not deliberately textured) or may be textured.

The substrate may have a surface area of a few square millimeters to several thousands of square meters. In an embodiment, the surface of the substrate may have a surface area of 10 square nanometers to 1000 square meters, preferably 100 square nanometers to 100 square meters, preferably 1 square centimeter to 1 square meter.

In an embodiment, electrically insulating substrates may include ceramic substrates, or polymeric substrates. Ceramic substrates include metal oxides, metal carbides, metal nitrides, metal borides, metal silicides, metal oxycarbides, metal oxynitrides, metal boronitrides, metal carbonitrides, metal borocarbides, or the like, or a combination thereof. Examples of ceramics that may be used as the substrate include silicon dioxide, aluminum oxide, titanium dioxide, zirconium dioxide, cerium oxide, cadmium-oxide, titanium nitride, silicon nitride, aluminum nitride, titanium carbide, silicon carbide, titanium niobium carbide, stoichiometric silicon boride compounds (SiBn, where n=14, 15, 40, and so on) (e.g., silicon triboride, SiB3, silicon tetraboride, SiB4, silicon hexaboride, SiB6, or the like), or the like, or a combination thereof.

Organic polymers that are electrically insulating may also be used as the substrate and may be selected from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole.

Examples of the organic polymers are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polyethylene terephthalate, polybutylene terephthalate, polyurethane, polytetrafluoroethylene, perfluoroelastomers, fluorinated ethylene propylene, perfluoroalkoxyethylene, polychlorotrifluoroethylene, polyvinylidene fluoride, polysiloxanes, or the like, or a combination thereof.

Examples of polyelectrolytes are polystyrene sulfonic acid, polyacrylic acid, pectin, carrageenan, alginates, carboxymethylcellulose, polyvinylpyrrolidone, or the like, or a combination thereof.

Examples of thermosetting polymers include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

The polymers and/or ceramics may be in the form of films, fibers, single strands of fiber, woven and non-woven fibers, woven fabrics, slabs, or the like, or a combination thereof. The fibers may be treated with surface modification agents (e.g., silane coupling agents) to improve adhesion if desired.

In addition to fibers, fabrics, yarns and textiles, the present technique may be used to coat and/or encapsulate other substrates of interest for other applications. For instnance, exemplary substrates are flat sheets, such as paper, Tyvek, polymeric sheets including the polymer sheets listed above, porous, planar membranes, such as CELGARD®, or cylindrical or curved objects, such as monofilament NYLON® thread, single-ply silk thread, or monofilament fiberglass thread.

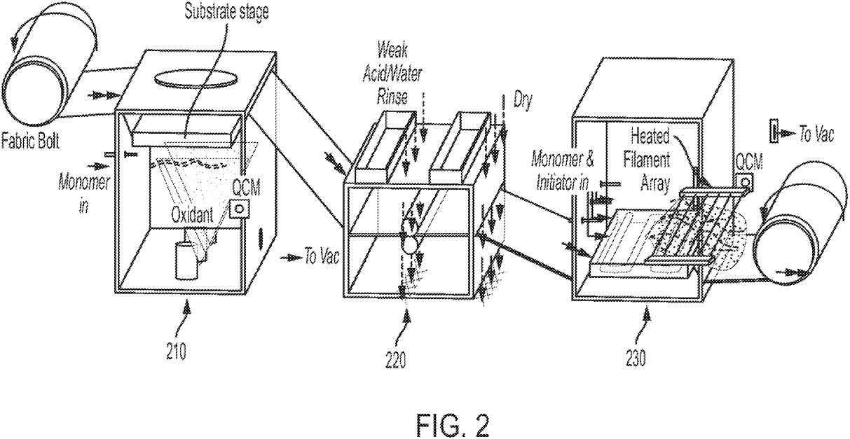

FIG. 2 illustrates a system 200 for producing electrically conductive 210 yarn, fiber or fabric that is rinsed in acid 220 and encapsulated with a protective coating 230 in which the raw material is continuously fed during processing. Coating chambers 210, 220, and 230 has been designed to maintain the appropriate vacuum notwithstanding the entrance and exit of the raw material. In the embodiment of FIG. 2, first the raw material is fed through a coating chamber 210. Next, the raw material is continuously fed to a cleaning chamber 220. Next, the raw material is continuously fed to an encapsulating chamber 230.

In one example, the vacuum can be maintained using self-induced friction amplification, in which pulling the fabric in a given direction causes the opening to clamp tighter on the fabric to create a seal. A well-known example of this type of sealing is the popular finger trap toy or towing stock device. In another example, an external vacuum housing similar to a glove box could also be implemented to maintain vacuum while feeding thread or fabric into the deposition chamber(s).

In yet another example, a single chamber could be used that includes all of the functions of the three chambers 210, 220, 230 e.g., in large scale factory production.

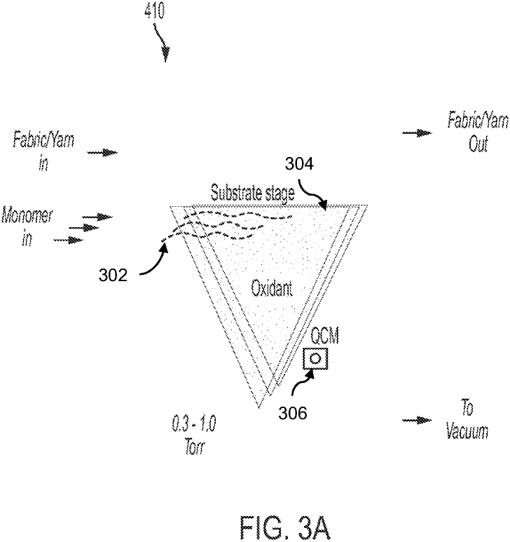

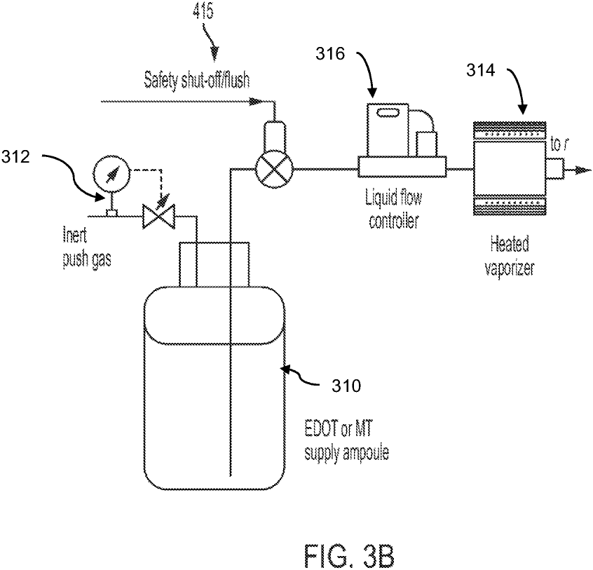

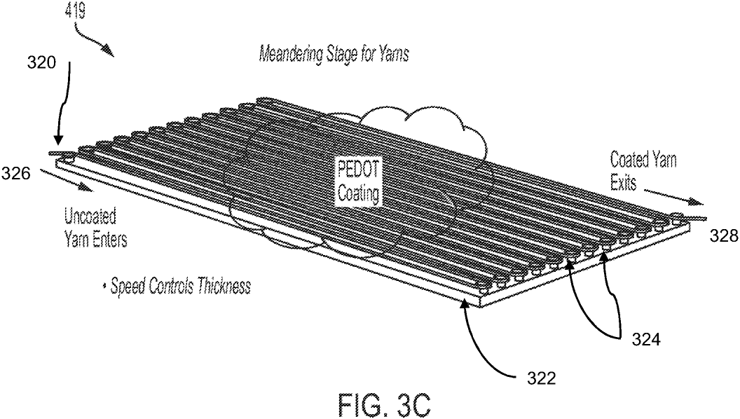

FIGS. 3A-3C depict further details of the coating chamber 410, e.g., chamber 110 (FIG. 1) or chamber 210 (FIG. 2). In the embodiment of FIG. 3A, the fabric, fiber or yarn 302 enters at the top of the chamber, contacts a heated substrate stage 304 placed above ports that introduce a monomer precursor for coating. A vacuum of 0.3-1.0 Torr is maintained using the techniques discussed above, and a QCM sensor 306 monitors the process.

In the embodiment of FIG. 3B, the monomer supply process is shown in additional detail. An EDOT supply ampoule 310 is carried using an inert gas supplied from an inlet 312 to the heated vaporizer 314. Additional components, including a safety shut-off 415 and a liquid flow controller 316 are used to ensure that the proper flow rate is maintained so that the material may be coated as the yarn is fed by the spooling mechanism discussed above.

In the embodiment of FIG. 3C, a meandering stage 419 designed for coating yarn 320 is shown. Meandering stage 419 includes a base 322 and a plurality of rotating guides 324 that are spaced along the left side and the right side of the base 322. When the meandering stage 419 is placed in chamber 410, as the yarn 320 is spooled, the yarn 320 to meander back and forth via the rotating guides 324 to ensure uniform coating and increased dwelling time. In one embodiment, separate meandering stages are used in each of the process chambers, i.e., the coating and encapsulation process chambers, and the speeds of spooling are matched and selected so that the coating process and encapsulation process leads to uniformly encapsulated and coated yarn, as the yarn 320 enters the meandering stage 419 at location 326 and exits the meandering stage at location 328. Applicant has discovered that the combination of a meandering stage with vapor deposition advantageously leads to a uniform coating.

FIG. 4 depicts further details of the cleaning chamber 520, which may be used as the cleaning chambers 120 (FIG. 1) or 220 (FIG. 2). To remove excess oxidant and achieve a stably-doped conductive polymer, the fabric or thread enters at port 424 and exits at port 426, and is rinsed using a monoprotic acid such as 0.1 moles per litre hydrochloric acid (HC1) delivered from source 420. As depicted in FIG. 4, the acid can be spray misted via source 420 through the textile or yarn. The textile or yarn can be dried by feeding through a set of squeegee rollers 428 followed by warm air blowing through it from dryer 422. The cleaning stage need not be carried out under vacuum, so in a separate chamber embodiment of the overall system can be used without vacuum. In a unified embodiment in which coating, cleaning, and encapsulation are all carried out in a single chamber, the cleaning process can also proceed under vacuum, with adjustments to how the rinse is removed via the outlet 430.

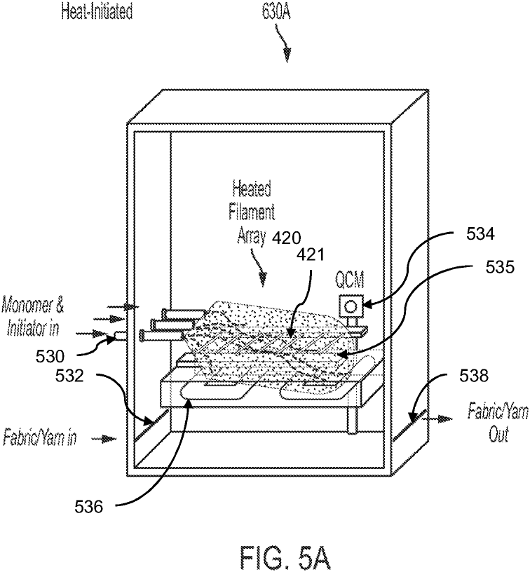

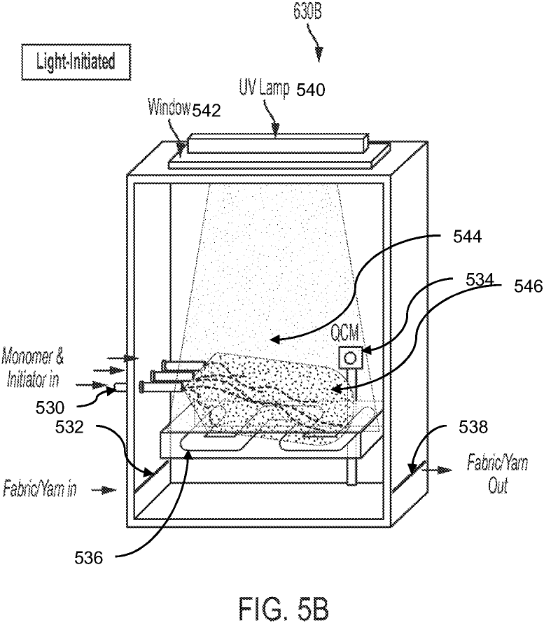

FIGS. 5A & 5B depicts further details of a chamber 630A which may be used interchangeably with any of the chambers described above, e.g., chambers 130 (FIG. 1) or 230 (FIG. 2). In the heat-initiated embodiment of FIG. 5A, the monomer and initiator are fed into the chamber 630B via inlet 530 and heated by a heated filament array 420, which includes a metal structure 421 that distributes heat for vapor phase polymerization 535 (which is depicted in an exaggerated mannerr as a mist of particles). The yarn enters at input 532 and exits at output 538 and is coated with the in the manner described above. In one embodiment, a quartz crystal microbalance (QCM) sensor 534 is used to determine that the correct thickness has been achieved.

In the embodiment of FIG. 5B, instead of heating the monomer and initiator, a UV lamp 540 is placed at the top of chamber 630B, and the UV light (wavelength <400 nm) 544 shines through the window 542 at the top of chamber 630B and interacts with the monomer and initiator for vapor phase polymerization 546.

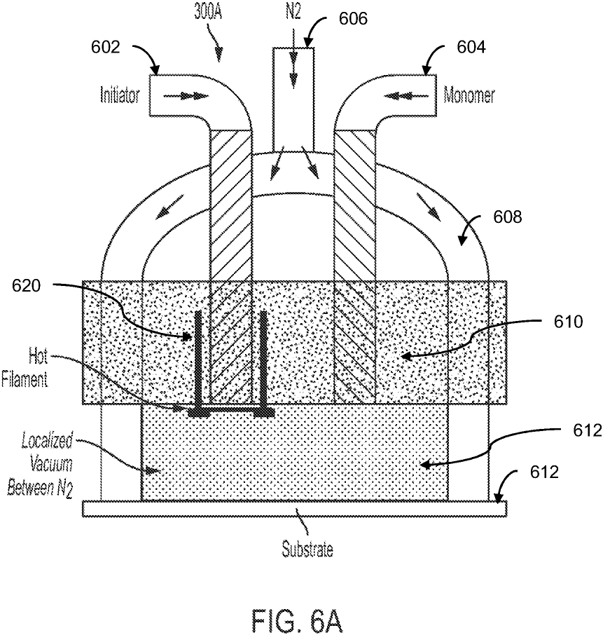

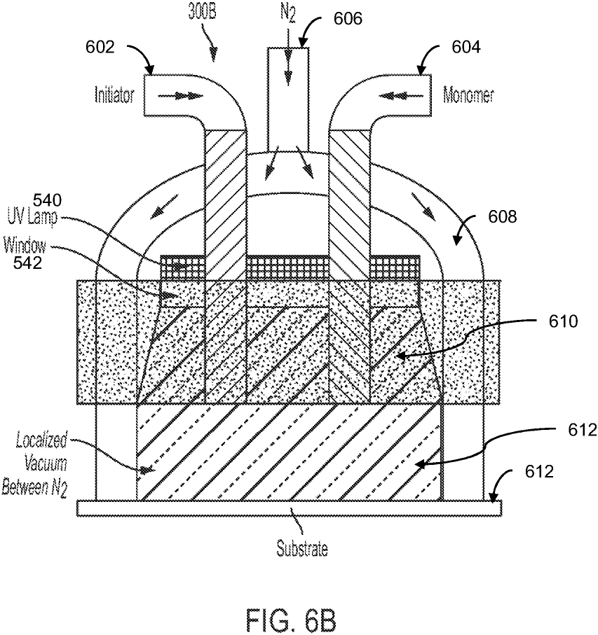

FIG. 6A illustrates a print head 300A for producing electrically conductive patterns onto any substrate 612, such as a flat or smooth plastic, paper, transparent conducting oxide or metal oxide surface, or nonwoven, prewoven or knit fabric surface, in which EDOT monomer and solid oxidant, such as Fe(III) salts or Copper(II) salts, vapors are sprayed to form PEDOT directly on the surface. The print head 300A includes an initiator inlet 602 and a monomer inlet 604 for the aforementioned oxidant and monomer, or any other variation disclosed herein, as well as a carrier gas inlet 606, and a manifold 608 that distributes the gases to an interior of the print head where the polymerization 610 begins prior to deposition on the substrate 612. This print head is capable of printing complexly patterned conductive polymer lines and shapes, i.e. the shape of a hand, and it can print in a resolution as small as 10 microns. The body of the print head is in the shape of a cylinder. It is made of alumina or another thermally stable ceramic that has feedthroughs for resistively heated filaments 620 such as tungsten and thermocouples for controlling power delivery and maintaining temperature. The heated filament coils within the body of the print head to heat the bottom of the EDOT reservoir, sidewalls, and tip of the funnel that delivers the oxidant. The EDOT monomer is held in a reservoir, and it can feature a carrier gas line to help deliver EDOT vapor to the substrate. The oxidant is contained in a reservoir above the funnel section of the ceramic body, and an auger screw can be incorporated to control the delivery of oxidant to the heated funnel section, which then leads to the substrate. The hottest part of the funnel section is near the tip, and this is achieved by having more wraps of the heated filament closer to the tip. The resistively heated filaments will heat the body of the ceramic causing the EDOT monomer to vaporize and the oxidant to sublimate. The two vapors will then flow out and down, and they will interact above the surface to coat it in PEDOT. The height between the surface of the substrate and the tip of the print head can be 0.1-1.0 mm.

In the embodiment of FIG. 6A, system 300A is a heat initiated print head for printing an encapsulating polymer onto any flat or smooth plastic, paper, transparent conducting oxide or metal oxide surface, or nonwoven, prewoven or knit fabric surface. This print head is an inkjet printer head, e.g., less than 10 cm wide and located approximately 1-10 mm in distance from the substrate surface. The printer head is equipped with nitrogen gas jets, monomer feed, and initiator feed. Nitrogen gas is used to help carry the monomer and initiator vapors out of their ampules, and the monomer and initiator ampules can have a similar setup as FIG. 3B. The nitrogen gas jets creates a vacuum space, such that the chemical reaction occurs in a localized vacuum area on the substrate. The monomer and initiator vapors are mixed before flowing past the nichrome filament, and they are flowed in this localized vacuum area because the presence of oxygen inhibits the polymerization. The vaporized monomer/initiator mix will flow past a resistively heated nichrome filament that is heated between 150-400° C. before reaching the substrate to initiate radicals that in turn radicalize the monomer so it can polymerize the encapsulating material on the substrate surface. Openings for monomer/initiator are in the range of e.g., 10 to 100 micrometers in diameter, in one embodiment.

In the embodiment of FIG. 6B, system 300B is light initiated. The print head of system 300B would function similarly as 300A (see common reference numbers as discussed above), but instead of generating radicals using heated nichrome wires of filament 620, it will generate radicals using UV light (wavelength <400 nm) introduced from UV lamp 540 via window 542. In this case, the nichrome filament 620 is not needed. The UV light will flood the space through which the monomer and initiator vapors will travel, the distance between tip of the print head and substrate, and the substrate. The substrate-facing part of the print head would be made up of a quartz glass such as to allow UV light (wavelength <400 nm) through.

With respect to the print head embodiment described above, conventional print heads are known for printing using liquid inks. For example, conventional inkjet printer propel a liquid ink onto paper in order to produce a pattern using either heat, pressure, or a combination thereof in a conventional manner that is well understood and well known to the ordinary artisan in the field. But conventional print heads are incapable of delivering two components that are supposed to react, and even further lack the concept of having an initiation means, such as heat or light, to cause such as reaction. Conventional print heads are designed for speed, and printing onto flat paper only, have no facility for initiating chemical reactions, and thus cannot be used to create an electrically conductive polymer coating as described herein. A person of ordinary skill in the art will understand that conventional ink jet printers include both one or more print heads and a control mechanism that allows the print heads, which include may include numerous output nozzles for different color inks, to move back and forth along a sheet of paper in order to print the required pattern. Such control mechanisms may be used with the present technique so that the presently described innovative print heads may move back and forth over any of the types of substrates described herein to form an electrically conductive and encapsulated coating on those substrates.

Advantageously, the presently disclosed vapor deposition print head includes light initiated or heat initiated polymerization of a monomer and an initiator so that an electrically conductive material such as PEDOT can be conformally deposited on a substrate such as a yarn, fiber, fabric or textile. The print head can also include another nozzle from which an encapsulating material is delivered. The control mechanism can then time the delivery of the materials so that as the print head moves above the substrate, a fully encapsulated, electrically conductive polymer such as PEDOT is delivered to the substrate in whatever pattern is desired. Because the vapor phase polymerization can occur within a short distance such as a few centimeters, the result is a substrate that is conformally coated and encapsulated with the conductive polymer.

Many examples of the utility of the present disclosure have been contemplated by the inventors, including heated gloves, hats, and other clothing, printed circuits that are embedded onto clothing to form wearable devices, etc. Various other applications of the present disclosure have been contemplated, including wearables that provide heat to a user, monitor the users health by measuring electric signals and temperatures, allow for mounting of other components such as blood pressure or oxygen sensors, etc.

Therefore, and as discussed above, generally stated, provided herein are a variety of techniques for coating electrically conductive polymer onto flat or smooth plastic, paper, transparent conducting oxide or metal oxide surface, or nonwoven, prewoven or knit fabric surface that is encapsulated with an insulating material. The various components FIGS. 1-6B can be rearranged or combined in different ways to construct systems for producing the yarn, fiber or fabric. For instance, any of the chambers 110, 120, 130, 210, 220, 230, 410, 520, 630A, or 630B can be mixed and matched to provide a system in accordance with the present disclosure. In addition, the process details discussed with respect to the chamber based embodiments are also applicable to the printer/spray head embodiments 300A, 300B and 300C. In addition, certain well-known details have only been touched upon, such as the use of an inert carrier gas to carry the chemicals through the process chamber, the use of vacuum pumps to maintain a vacuum, the use of motors and other details of the spooling mechanism, etc., that a person of ordinary skill in the art would understand.

The fact that one or more specific embodiments for coating, cleaning and encapsulating have been used to illustrate the concepts of the present technique are not meant to limit the disclosure in any manner. Indeed, as noted above, the concepts disclosed herein are not limited to textiles, yarns, fibers or fabrics. For example, many other applications of the different processes described herein have been envisaged by the inventors and are included within the scope of this disclosure. The presentation of a specific set of claims herein is not meant to limit scope, but is only done to illustrate some of the example embodiments which are covered by this disclosure. For example, the techniques described herein may be scaled in size from a large factory embodiment measuring many yards in each direction down to a smaller table-top apparatuses that are only a few feet in size. In addition to fiber, fabric, and yarn embodiments, the present disclosure could be used for producing circuits that are printed on any of the substrates identified above, and the coating and encapsulation process can be used to form the conductive lines of the circuit. By adding other electrical or semiconductor elements in a manner known in the art, the end product would be a wearable or non-wearable circuit or electronic device that could be conformed to any surface or configuration, providing great advantages compared to flat circuit boards presently used in the field.

1. A system for continuously producing electrically conductive yarn, fiber or fabric, the system comprising:
a first process chamber for coating the yarn, fiber or fabric with an electrically conductive polymeric material, wherein the first process chamber introduces a precursor and an initiator that form the electrically conductive polymeric material;
a second process chamber for encapsulating the electrically conductive yarn, fiber or fabric with an encapsulating insulating material;
a first spooling mechanism that stores the yarn, fiber or fabric within the first process chamber and flows the yarn, fiber or fabric through the first process chamber during the coating; and
a second spooling mechanism that accepts the yarn, fiber or fabric such that the yarn, fiber or fabric continuously flows in the direction from the first process chamber to the second process chamber, wherein the flow rate of the first and second spooling mechanisms are selected to allow the yarn, fiber or fabric to be coated with the electrically conductive material and encapsulated with the encapsulating material, wherein the yarn, fiber or fabric is subsequently spooled after the encapsulating to form a spool of yarn, fiber or fabric.

2. The system of claim 1, wherein the first and second process chambers are combined as a single process chamber, wherein separation of the coating and the encapsulating is achieved through one or more of space or a physical barrier within the single process chamber.

3. The system of claim 1, wherein the process chamber comprises vapor phase introduction of the precursor and the initiator, wherein the precursor and initiator begin reacting in the vapor phase and the coating is formed conformally around the yarn, fiber or fabric as a molecular layer, wherein the forming process as a molecular layer retains flexibility of the yarn, fiber or fabric after the coating.

4. The system of claim 1, wherein the precursor is 3,4-ethylenedioxythiophene.

5. The system of claim 1, wherein the electrically conductive material comprises p-doped poly(3,4-ethylenedioxythiophene).

6. The system of claim 1, wherein the electrically conductive material comprises p-doped poly(3,4-ethylenedioxythiophene) and the encapsulating material comprises an acrylate.

7. A device for printing a pattern of encapsulating and/or electrically conductive polymer onto a substrate, comprising:
a control mechanism;
a stage for holding the substrate;
at least one print head controlled by the control mechanism to move relative to the substrate, the at least one print head comprising:
one or more outlets for delivering a precursor and a monomer to a target zone;
one or more outlets for delivering an encapsulating material to the target zone;
an initiation mechanism for initiating a vapor phase reaction of the precursor and the monomer within the target zone so that the monomer polymerizes to form an electrically conductive polymer;
wherein the control mechanism controls the print head to move relative to the substrate such that the substrate is coated with a pattern of the electrically conductive polymer and protected with the encapsulating material when the substrate is within the target zone of the print head.

8. The device of claim 7, wherein the at least one print head comprises a first print head for coating the surface with the electrically conductive material, and a second print head for encapsulating the electrically conductive material with an encapsulating material.

9. The device of claim 7, wherein the at least one print head comprises a single print head for coating the surface with the electrically conductive material, and for encapsulating the electrically conductive material with an encapsulating material.

10. The device of claim 7, wherein the at least one print head uses heat-based initiation to coat with the encapsulating material.

11. The device of claim 7, wherein the at least one print head uses light-based initiation to coat with the encapsulating material.

12. The device of claim 7, wherein the electrically conductive material comprises p-doped poly(3,4-ethylenedioxythiophene).

13. The device of claim 7, wherein the encapsulating material comprises a poly(acrylate).

14. The device of claim 7, wherein the electrically conductive material comprises p-doped poly(3,4-ethylenedioxythiophene) and the encapsulating material comprises a poly(acrylate).

15. The device of claim 7, wherein the device comprises a portable unit, the device further comprising a battery and movable material tanks for storing.

16. The device of claim 7, wherein the device further comprises an outlet for delivering a cleaning solution to the yarn, fiber or fabric.

17. The device of claim 7, wherein the electrically conductive material comprises p-doped poly(3,4-ethylenedioxythiophene) and the encapsulating material comprises an acrylate.
